(19) United States
(12) Patent Application Publication
(10) Pub. No.: US 2010/0314571 A1
(43) Pub. Date: Dec. 16, 2010

(54) Unitary Flapper Base and Method of Manufacture

(75) Inventors: Tyler C. Roberts, Owasso, OK (US); Barry Lee Brown, Tulsa, OK (US); John E. Gunnells, Broken Arrow, OK (US); James T. Sloan, Tulsa, OK (US)

Correspondence Address: Shawn Hunter / Baker Hughes Filings, P.O. Box 270110, Houston, TX, 77277-0110, US

(73) Assignee: Baker Hughes Incorporated, Houston, TX (US)

(21) Appl. No.: 12/484,671

(22) Filed: Jun. 15, 2009

(51) Int. Cl. F16K 15/03; B21K 1/24

(52) U.S. Cl. 251/359; 29/890.122; 137/527.6

(57) ABSTRACT

A flapper base provides a flapper base body with a hinge portion unitarily formed thereupon and a flapper seat surface formed within the flowbore of the body. The flapper base may be formed from a single section of tubular metallic stock. In a method of forming a base, the stock is gripped by a rotary clamp, and a five-axis milling machine is used to cut away portions of the stock section and to form the seat surface.

### BACKGROUND OF THE INVENTION

1. Field of the Invention

The invention relates generally to flapper-type safety valves of the type often used in subterranean hydrocarbon production wellbores and methods of manufacturing them.

2. Description of the Related Art

Surface-controlled, subsurface safety valves (“SCSSV's”) are typically used in production string arrangements to quickly close off the production flowbore in the event of an emergency, such as a blowout. A usual form for an SCSSV is a flapper-type valve that includes a flapper member that is pivotally moveable between open and closed positions within the flowbore. The flapper member is actuated between the open and closed positions by a flow tube that is axially moveable within the flowbore.

The flapper valve also includes a flapper base assembly which is incorporated into the string of tubing that defines the flowbore to be closed by the valve. The flapper base assembly presents a flapper seat, which is a sealing surface against which the flapper member closes and forms a fluid seal. A popular seat design is an undulating or “sine wave” configuration. This configuration is described, for example, in U.S. Pat. Nos. 5,682,921 and 5,918,858, both entitled “Undulating Transverse Interface for Curved Flapper Seal” by Rawson et al. Each of these patents is owned by the assignee of the present application and is hereby incorporated by reference in its entirety.

The flapper base assembly is typically made up of multiple separate components that are secured together by threading and connectors. Often, the assembly is made up of three major components, as shown in FIGS. 1 and 2. FIGS. 1 and 2 illustrate an exemplary prior art flapper base assembly 10 that is formed of a flapper seat 12 and a flapper base portion 14. The flapper seat 12 includes the shaped seat surface 16, against which the flapper member will seal. The base portion 14 radially surrounds the seat 12 and includes the hinge portion 18 to which the flapper member is attached. The seat 12 and the base 14 are secured together by a turnbuckle 20 via threaded connections 22 and 24, respectively. As can be seen in FIGS. 1 and 2, a circular rim 26 on the base portion 14 surrounds and extends axially from the shaped seat surface 16. An axial projection 28 also projects axially from the rim 26.

Great precision and close tolerances are needed for the manufacture of the components 12, 14, 20 of the flapper base assembly 10. Slight improper alignment between the components will create significant sealing problems in the completed valve.

Using current techniques to manufacture a flapper base assembly 10 the flapper seat component 12 is fabricated separately from the turnbuckle 20 and the base portion 14. FIG. 3 illustrates a part of an exemplary prior art manufacturing process wherein the seat surface 16 of the flapper seat component 12 is being cut by a cutter 28. The flapper seat 12 is being gripped by a clamp 30. The cutter 28 is located radially outside of the circumference of the seat surface 16 and is moved with respect to the seat 12 and clamp 30 in order to cut the shaped seat surface 16 by shaping the axial end of the seat component 12. The cutter 28 is moved axially in the directions indicated by arrows 32 in order to form the undulating shape of the seat surface 16. After the seat surface 16 has been formed, the opposite axial end 34 of the seat component 12 has threads formed thereupon, in a manner known in the art. The separate components 12,14 and 20 are then affixed together by threaded assembly.

### SUMMARY OF THE INVENTION

In preferred embodiments, the invention provides flapper base which has an exemplary unitarily-formed body. The flapper base body includes a shaped flapper valve seat surface against which a complimentary flapper member can close and seal as well as a hinge portion to which a flapper member will be attached.

The invention also provides methods of manufacturing or forming a flapper base from a unitary section of tubular stock. According to an exemplary method for forming a flapper base, a section of tubular stock is gripped within a rotary clamp. A milling machine is used to cut and partially form a hinge retainer portion at one axial end of the stock section. The milling machine is also used to form the flapper seat surface within the flowbore of the section of stock.

The devices and methods of the present invention permit the turnbuckle component to be eliminated from the flapper base, which can permit the overall thickness of the flapper base body to be reduced, if necessary. The reduction in the thickness of the flapper base body can permit the flapper base body to be formed with a larger diameter bore relative to the diameter of the exterior of the flapper base body.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a side, cross-sectional view of a prior art flapper valve base assembly.

FIG. 2 is an isometric view of the prior art flapper valve base assembly shown in FIG. 1.

FIG. 3 is an isometric view depicting a method for creating a component of the prior art valve base assembly shown in FIGS. 1 and 2.

FIG. 4 is a side, cross-sectional view of an exemplary flapper base constructed in accordance with the present invention.

FIG. 5 is an isometric view of the flapper base shown in FIG. 4.

FIG. 6 is a side, external view of an exemplary process step for forming a flapper base in accordance with the present invention.

FIG. 7 is a side, external view of a further exemplary process step for forming a flapper base in accordance with the present invention.

FIG. 8 is a side, external view depicting an exemplary process step of forming a seal retaining groove in the flapper base in accordance with the present invention.

FIG. 9 is a cross-sectional view taken along line 9-9 in FIG. 8.

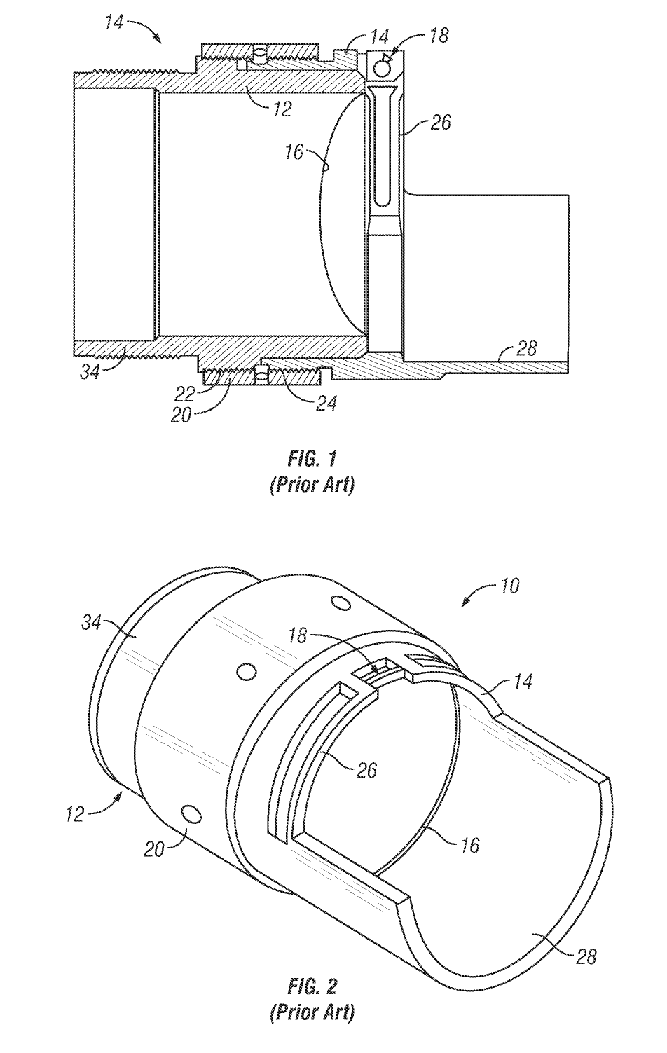

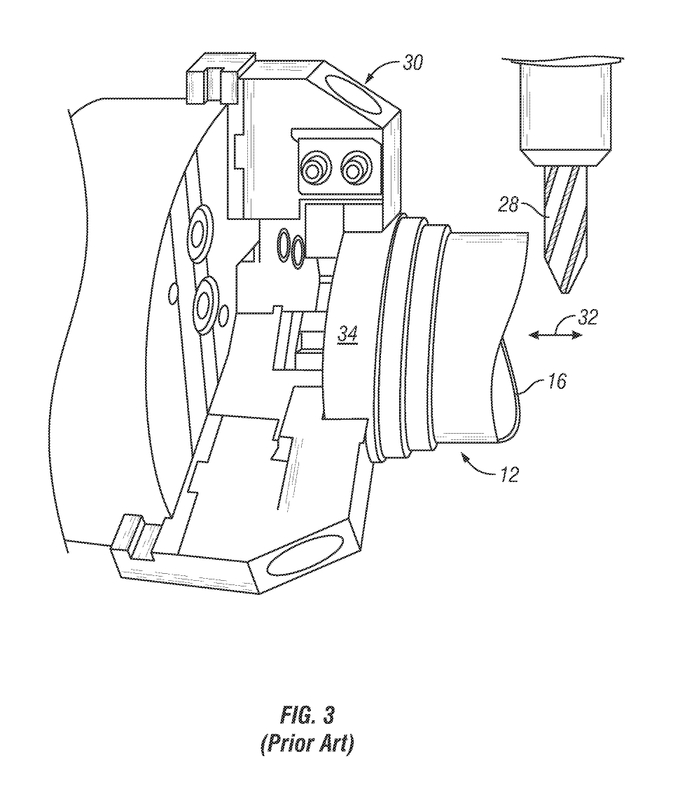

### DETAILED DESCRIPTION OF THE PREFERRED EMBODIMENTS

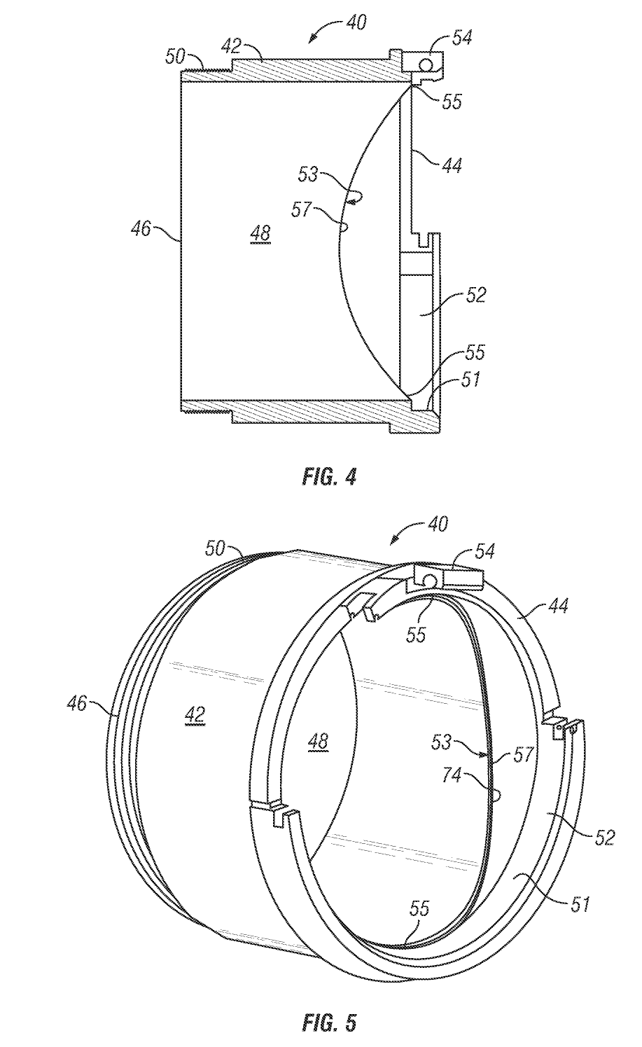

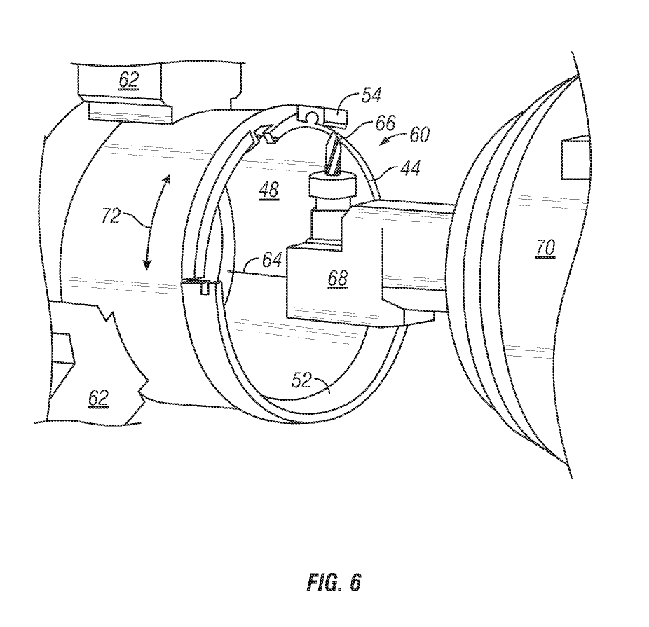

FIGS. 4 and 5 illustrate an exemplary flapper base 40 that is constructed in accordance with the present invention. The exemplary flapper base 40 has a unitary generally cylindrical body 42 which is preferably substantially formed of metal, such as 420 Modified or Nickel Alloy. The flapper base 40 includes a first axial end 44 and a second axial end 46 and defines a central axial flowbore 48. The second axial end 46 has external threads 50 to permit the flapper base 40 to be affixed to an adjacent section of tubing within a production tubing string of other tubular string.

The first axial end 44 has a semi-circular, axially-projecting rim 52 with radial groove 51 for the retention of torsion springs (not shown) of a type known in the art for creating a spring-bias for the flapper member toward its closed position. A hinge pin retainer 54 also projects from the first end 44. The undulating, or sine wave shaped, seating surface 53 is located within the flowbore 48. As depicted in FIG. 4, the seating surface 53 includes opposed, axially raised portions 55 with opposed axially lowered portions 57 disposed therebetween, thereby having an undulating, or sine-wave, shape.

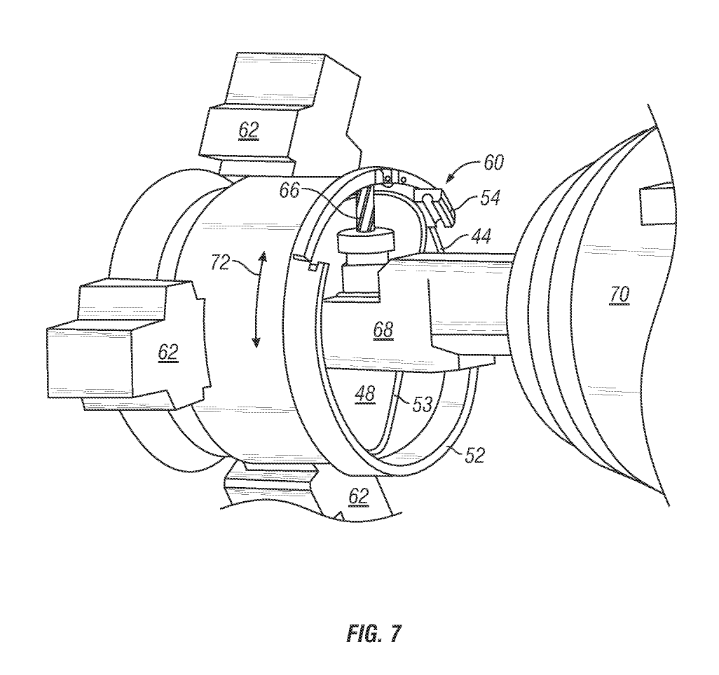

FIGS. 6 and 7 depict exemplary steps in a process of creating the flapper base 40. In FIGS. 6 and 7, a section of tubular metallic stock 60 is being gripped by gripping members 62 of a rotary clamp, of a type known in the art. The gripping members 62 are used to rotate the stock section 60 about its central longitudinal axis 64. A cutting blade 66 is mounted within a right-angle head 68 of a five-axis milling machine 70 of a type known in the art. A suitable five-axis milling machine for this application is a e-500H II model milling machine available commercially from Mazak Corporation of Florence, Ky. The right-angle head 68 causes the cutting blade 66 to be directed at an angle that is deviated approximately 90 degrees from, or orthogonal to, the central axis 64 and directed radially outwardly from the axis 64. It is noted that the right-angle head 68 is located radially within the flowbore 48 of the stock section 60.

FIG. 6 depicts the milling machine 70 using the cutting blade 66 to cut away portions of the stock section 60 at the first axial end 44 in order to form the rim 52 and hinge pin retainer 54. The gripping members 62 rotate the stock section 60 in the radial directions indicated by arrows 72. The right angle head 68 may be moved as necessary to cut away the portions of the stock section 60 necessary to form the retainer 54 and rim 52. Milling may be performed manually. But preferably, the milling operation is performed using suitable programming of the milling machine.

FIG. 7 illustrates the cutting blade 66 of the milling machine 70 forming the seat surface 16 within the flowbore 48 of the stock section 60. The stock section 60 is rotated in the direction of arrows 72, as the right angle head 68 moves the cutter 66 as necessary to form the seat surface 53. It is noted that the seat surface 53 is milled into the interior surface of the flowbore 48. Body material is removed from the interior surface of the flowbore 48 at the first end 44 so that the seat surface 53 results.

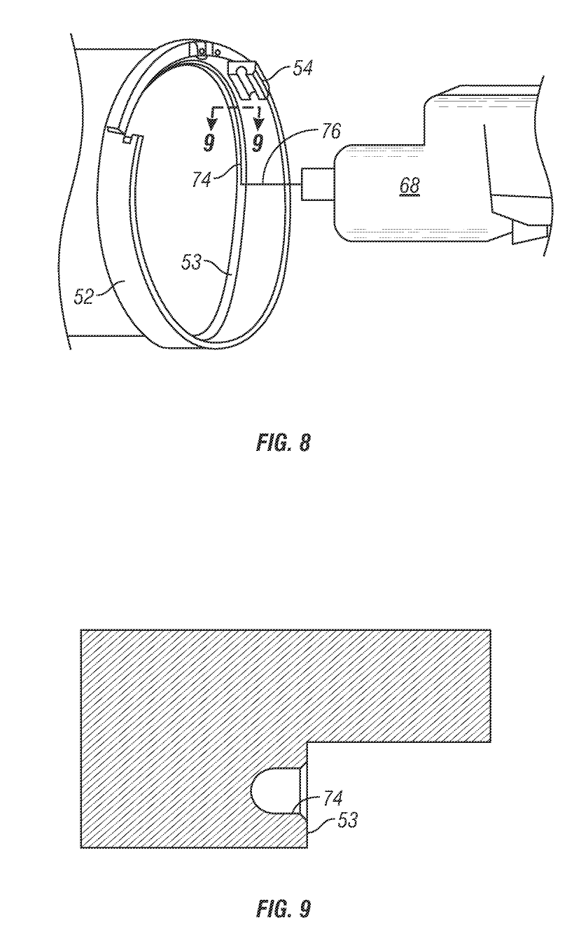

As depicted in FIGS. 8 and 9, a groove 74 is then cut into the seat surface 53 to retain a resilient seal, such as an elastomeric seal, to provide fluid sealing between the flapper base 40 and an attached flapper member. FIG. 8 illustrates formation of the groove 74 using a ball-nosed end mill cutting head 76. FIG. 9 is a cross-sectional view depicting the completed groove 74. External threads, such as threads 50, are preferably thereafter formed into the stock section 60.

The foregoing description is directed to particular embodiments of the present invention for the purpose of illustration and explanation. It will be apparent, however, to one skilled in the art, that many modifications and changes to the embodiment set forth above are possible without departing from the scope and the spirit of the invention.

What is claimed is:

1. A flapper base for a flapper valve, comprising:
a generally cylindrical flapper base body defining an axial flowbore;
a hinge retainer for securing a flapper member to the flapper base unitarily formed within the flapper base body; and
a flapper seat surface against which a flapper member will close and seal that is unitarily formed within the flowbore of the body.

2. The flapper base of claim 1 wherein the flapper seat surface has a sine-wave configuration.

3. The flapper base of claim 1 wherein the flapper base body is substantially formed of metal.

4. The flapper base of claim 1 further comprising a groove formed within the flapper seat surface to receive a resilient seal.

5. A method of making a flapper valve base for a flapper valve, the method comprising the steps of:
gripping a section of tubular stock within a clamp, the stock section having an axial end and defining an axial flowbore with a longitudinal axis;
cutting away portions of the stock section to at least partially form a hinge retainer portion on the body to which a flapper member will be pivotally secured; and
forming a flapper seat surface within the flowbore against which a flapper member will close.

6. The method of claim 5 wherein the flapper seat surface is formed by a five-axis milling machine.

7. The method of claim 6 wherein the five-axis milling machine includes a right-angle head which retains a cutting member at an angle that is substantially orthogonal to the longitudinal axis of the stock section.

8. The method of claim 7 wherein the cutting member is directed radially outwardly from the longitudinal axis.

9. The method of claim 5 wherein the clamp is a rotatable clamp and wherein the stock section is rotated by the clamp about the longitudinal axis during forming of the flapper seat surface.

10. The method of claim 5 further comprising the step of forming a groove within the flapper seat surface for retaining a resilient seal.

11. A flapper base for a flapper valve, the flapper base comprising:
a generally cylindrical body having first and second axial ends and defining a flowbore; and
a flapper seat surface that is milled into a sidewall of the flowbore and against which a flapper member will close.

12. The flapper base of claim 10 further comprising a hinge retainer portion integrally formed on the body for pivotal interconnection of a flapper member.

13. The flapper base of claim 10 wherein the body is substantially formed of metal.

14. The flapper base of claim 10 wherein the body further includes external threads.

15. The flapper base of claim 10 wherein the flapper seat surface includes a groove for retaining a resilient seal.
